(19) United States
(12) Patent Application Publication
(10) Pub. No.: US 2006/0071569 A1
(43) Pub. Date: Apr. 6, 2006

(54) Stator end caps and methods for positioning the lead and exit ends of the stator windings

(76) Inventors: William P. Stewart, Saint Peters, MO (US); Raymond D. Heilman, Florissant, MO (US); Paul G. Michaels, Saint Louis, MO (US)

Correspondence Address: HARNESS, DICKEY, & PIERCE, P.L.C, 7700 BONHOMME, STE 400, ST. LOUIS, MO, 63105, US

(21) Appl. No.: 10/958,215

(22) Filed: Oct. 4, 2004

(51) Int. Cl. H02K 3/00; H02K 1/00; H02K 19/26

(52) U.S. Cl. 310/194

(57) ABSTRACT

An electric machine includes a segmented or non-segmented stator and an end shield defining at least one opening therein. The machine also includes at least one winding having a lead end and an exit end, and at least one end cap coupled to the stator. The end cap defines first and second grooves which are respectively engaged with either the lead end or exit end of the winding. The end cap guides the lead and exit ends through the opening in the end shield.

### FIELD

The present invention generally relates to electric machines, and more particularly (but not exclusively) to stator end caps and methods for positioning and retaining the position of lead and exit ends of the stator windings.

### BACKGROUND

Location and axial control of the start and finish turns of the wound segments are left largely to chance particularly when using heavy gauge wire, which can be used to form stator windings. Therefore, secondary manipulation of the lead and exit ends of the stator windings is normally required to connect the stator windings to electronics.

For example, many applications use secondary components, such as intermediate connectors, leads, and/or lead frames, to connect the stator windings to the electronics. But these secondary components add processes and costs to the manufacture and assembly of the electric machine. The secondary components can also increase electrical resistance and hinder (or even prevent) the implementation of a fully automated assembly process.

### SUMMARY

In one implementation, an electric machine includes a segmented or non-segmented stator and an end shield defining at least one opening therein. The machine also includes at least one winding having a lead end and an exit end, and at least one end cap coupled to the stator. The end cap defines first and second grooves which are respectively engaged with either the lead end or exit end of the winding. The end cap guides the lead and exit ends through the opening in the end shield.

In another implementation, an electric machine includes a segmented stator having a plurality of stator segments, and an end shield defining a plurality of openings therein. The machine also includes a plurality of windings each including a lead end and an exit end, and a plurality of end caps each coupled to a different one of the stator segments. Each end cap defines first and second grooves which are respectively engaged with either a lead end or an exit end from one of the windings. Each end cap guides a corresponding pair of lead and exit ends through a different one of the openings in the end shield.

In another aspect, the present invention provides end caps for a segmented or non-segmented stator. In one implementation, an end cap defines first and second grooves sized to engage one of a lead end and exit end of a winding. The end cap guides and retains the position of the lead and exit ends engaged within the respective first and second grooves.

In yet another aspect, the present invention provides methods for positioning and retaining the position of lead and exit ends of at least one winding of an electric machine. In one implementation, the method generally includes engaging the lead and exit ends within first and second grooves defined by an end cap coupled to a stator. The end cap guides the lead and exit ends engaged within the first and second grooves through at least one opening in an end shield.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an inner perspective view of an end cap coupled to a unwound stator segment according to an exemplary embodiment of the invention;

FIG. 2 is an exploded inner perspective view of the end cap showing the two pieces aligned for engagement with the stator segment shown in FIG. 1;

FIG. 3 is an exploded side elevation view of the end cap shown in FIG. 2;

FIG. 4 is a inner perspective view of the end cap and stator segment shown in FIG. 1 and also showing a stator winding coupled to the end cap;

FIG. 5 is a side elevation view of the end cap, stator segment, and stator winding shown in FIG. 4;

FIG. 6 is an outer perspective view of the end cap, stator segment, and stator winding shown in FIG. 4;

FIG. 7 is a perspective view showing the engagement of the stator winding's lead and exit ends within the grooves and reliefs of the end cap shown in FIG. 4;

FIG. 8 is a bottom plan view showing the engagement of the stator winding's lead and exit ends within the grooves of the end cap shown in FIG. 7;

FIG. 9 is a top plan view of the upper end cap piece shown in FIG. 2;

FIG. 10 is a bottom plan view of the upper end cap piece shown in FIG. 2;

FIG. 11 is a top plan view of the lower end cap piece shown in FIG. 2;

FIG. 12 is a bottom plan view of the lower end cap piece shown in FIG. 2;

FIG. 13 is an upper perspective view showing a plurality of end caps coupled to a segmented stator on an end shield according to an exemplary embodiment of the invention;

FIG. 14 is an lower perspective view of the end caps, segmented stator, and end shield shown in FIG. 13 and showing the end caps guiding the stator windings' lead and exit ends through openings in an end shield;

FIG. 15 is an inner perspective view of the end caps, segmented stator, and end shield shown in FIG. 13 positioned within a housing and also showing an electronics mount and power and control electronics aligned for positioning within the housing according to an exemplary embodiment of the invention; and

FIG. 16 is a lower perspective view showing a plurality of end caps coupled to a non-segmented stator on an end shield according to an exemplary embodiment of the invention.

Corresponding reference numerals indicate corresponding parts throughout the several views of the drawings.

### DETAILED DESCRIPTION OF THE EXEMPLARY EMBODIMENTS

The following description of the exemplary embodiments is merely exemplary in nature and is in no way intended to limit the invention, its application, or uses.

According to one aspect, the present invention provides end caps for use with stators. The stator may be a non-segmented stator or a segmented stator. In one implementation, an end cap defines first and second grooves sized to engage one of a lead end and exit end of a winding. The end cap guides and retains the position of the lead and exit ends engaged within the respective first and second grooves. This, in turn, enables the stator winding to be connected directly to electronics without secondary connections/lead frames and the associated processes, costs, increased electrical resistance, and electrical current reductions. By properly positioning and retaining the position of the stator winding lead and exit end, the end cap can facilitate automated assembly and integration of power and control electronics into the primary machine housing. Further aspects of the invention include electric machines, electric motors, electric superchargers, vehicles (e.g., automobiles, etc.), switched reluctance motors, brushless permanent magnet (BPM) motors, induction motors, and electric generators that include one or more end caps of the present invention.

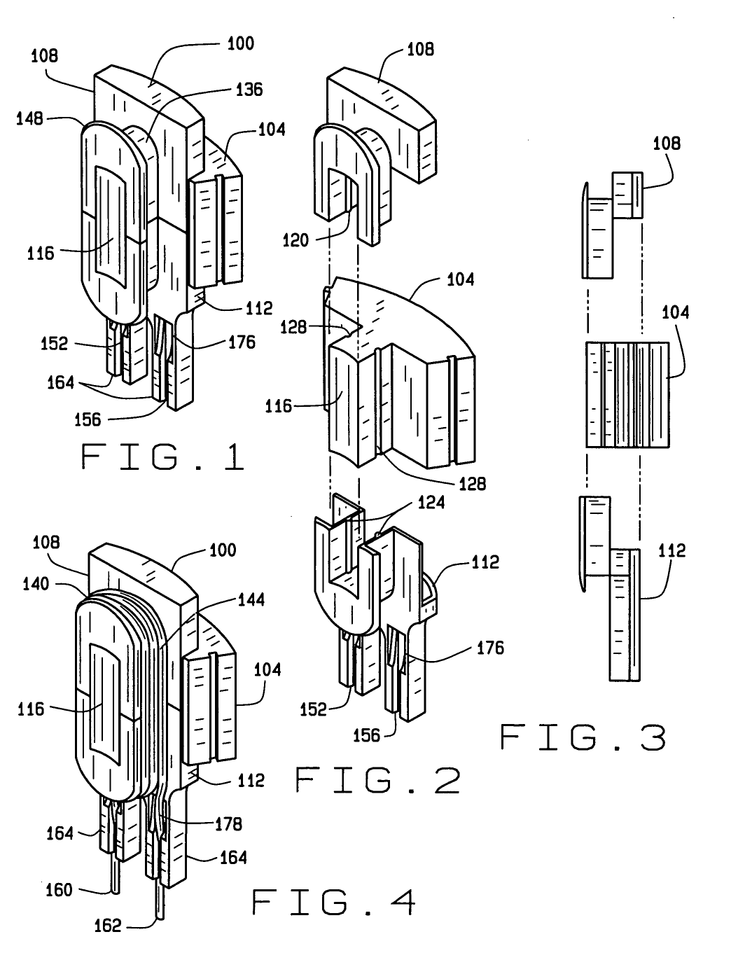

FIG. 1 illustrates an exemplary end cap 100 coupled to an unwound stator segment 104 in accordance with the principles of this invention. As shown, the end cap 100 includes first and second pieces 108 and 112 slidably positioned generally around an engagement member 116 of the stator segment 104. Alternatively, other implementations can include a monolithic or single-piece end cap.

As shown in FIGS. 2, 10, and 11, the end cap pieces 108, 112 respectively define ribs or ridges 120, 124. Each rib 120, 124 is configured to be slidably received within a corresponding groove 128 defined by the stator engagement member 116. The engagement of the ribs 120, 124 with the grooves 128 removably secures the end cap pieces 108, 112 to the stator segment 104. In alternative embodiments, however, the end cap pieces can include no ribs or more than one rib depending on the particular application.

When engaged to the stator segment 104, the end cap pieces 108, 112 cooperate to define a generally curved surface 136 (FIG. 1) around which wire 140 can be wound to form a stator winding 144 (FIG. 4). In a preferred implementation, the stator winding 144 is formed by winding six turns of two-millimeter wire onto the generally curved surface 136. Alternative implementations, however, can include stator windings formed from more or less than six-turn windings and/or from wire that is larger or smaller than two-millimeter wire.

As shown in FIGS. 1, 4 and 5, the end cap 100 can also include a flange 148 disposed entirely around the generally curved surface 136. This flange 148 can help retain the wire 140 on the generally curved surface 136, thereby preventing (or at least reducing the possibility of) the wire 140 from entering the stator bore. While the figures show a single continuous flange 148 disposed entirely around the generally curved surface 136, other implementations can include a single wire retaining flange disposed only partially around the generally curved surface. Yet other implementations can include a plurality of wire retaining flanges extending entirely and/or partly around the generally curved surface.

The end cap 100 also includes grooves or slots 152, 156 as show in FIGS. 1, 2 and 12. These grooves 152, 156 are sized to engagingly receive the lead and exit ends 160,162 of the stator winding 144.

In the illustrated embodiment, the end cap 100 includes a pair of legs or extensions 164 each defining a different one of the grooves 152, 156. These legs 164, and thus the grooves 152, 156 defined thereby, extend axially away from the stator segment 104. Alternatively, other implementations can includes an end cap having a single leg that defines both grooves.

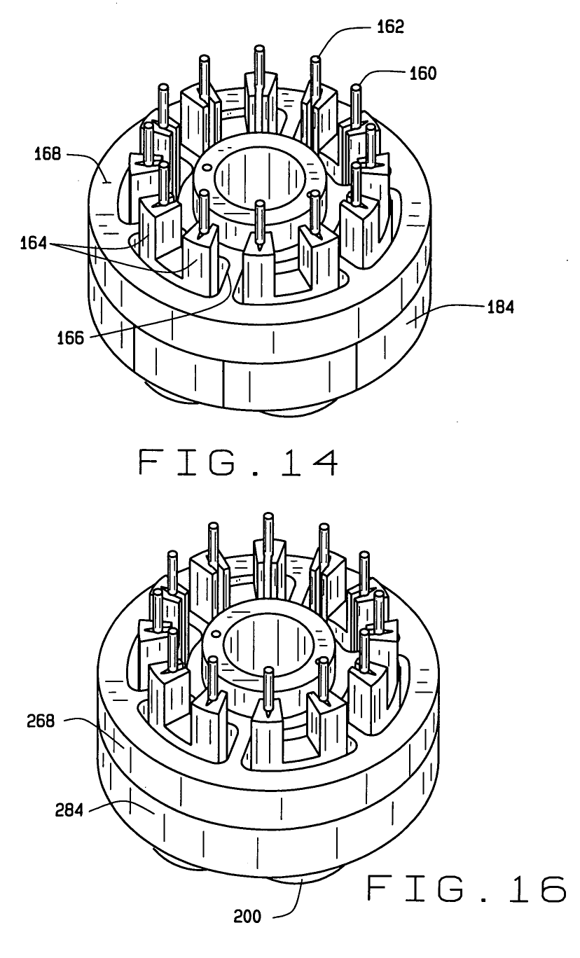

When the lead and exit ends 160, 162 are engaged within the respective grooves 152,156 (FIGS. 4, 7, and 8), the end cap 100 can guide the lead and exit ends 160, 162 through an opening 166 in an end shield 168 as shown in FIGS. 14 and 15. The end cap 100 can thus position and maintain the position of the lead and exit ends 160, 162, for example, for connection to a power and control electronics assembly 170 (FIG. 15) or other interconnections as required.

Further, the legs 164 and grooves 152, 156 defined thereby can have a sufficient length to extend through the circumferentially arranged windows 166 in the end shield 168, thereby positioning the lead and exit ends 160,162 closer to whatever electronics (e.g., power and control electronics assembly 170 in FIG. 15) that may ultimately be connected to the lead and exit ends 160,162.

In preferred implementations, the grooves 152, 156 are configured to form a snap-fit with the stator winding's lead and exit ends 160, 162, respectively. In the illustrated embodiment of FIG. 12, each groove 152, 156 includes a cross-section having a first generally u-shaped portion 172 and a narrower second generally u-shaped portion 174. This exemplary configuration for the grooves 152, 156 allows the lead and exit ends 160, 162 to be “snapped” into their corresponding groove 152, 156.

Referring now to FIGS. 1 and 7, the end cap 100 can also define a relief 176 adjacent each groove 152, 156. Each relief 176 can be configured to provide the location and room for a bend in the lead and exit ends 160, 162. When engaging the lead and exit ends 160, 162 with their corresponding grooves 152, 156, bent portions 178 of the lead and exit ends 160, 162 can be positioned within the corresponding relief 176, thereby allowing the wire 140 to lay flat in the grooves 152, 156. By way of example, the bent portions 178 can be pressed into the wire 140 even before it is wound onto the generally curved surface 136 of the end cap 100.

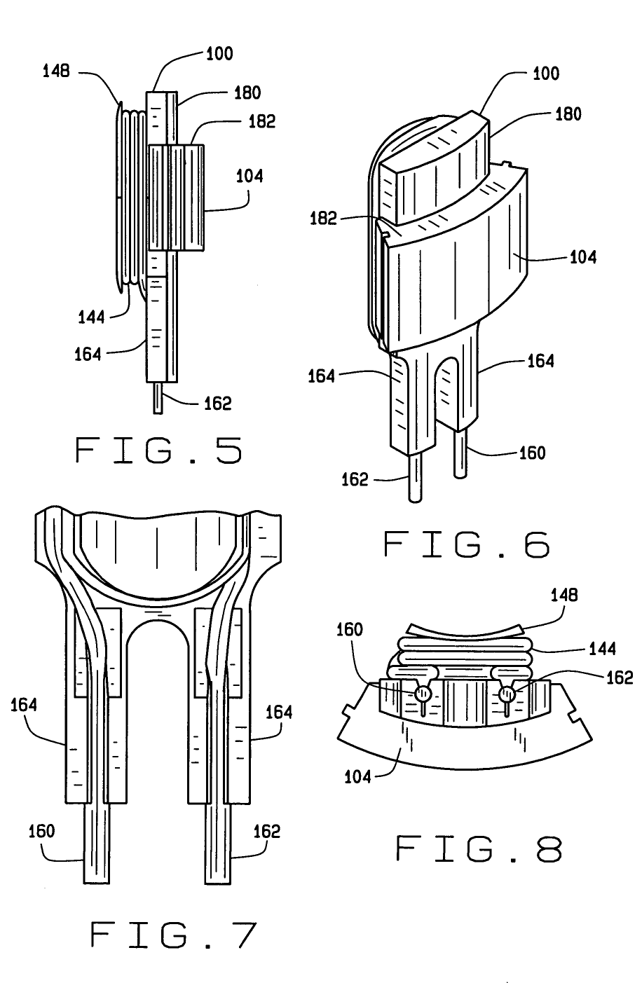

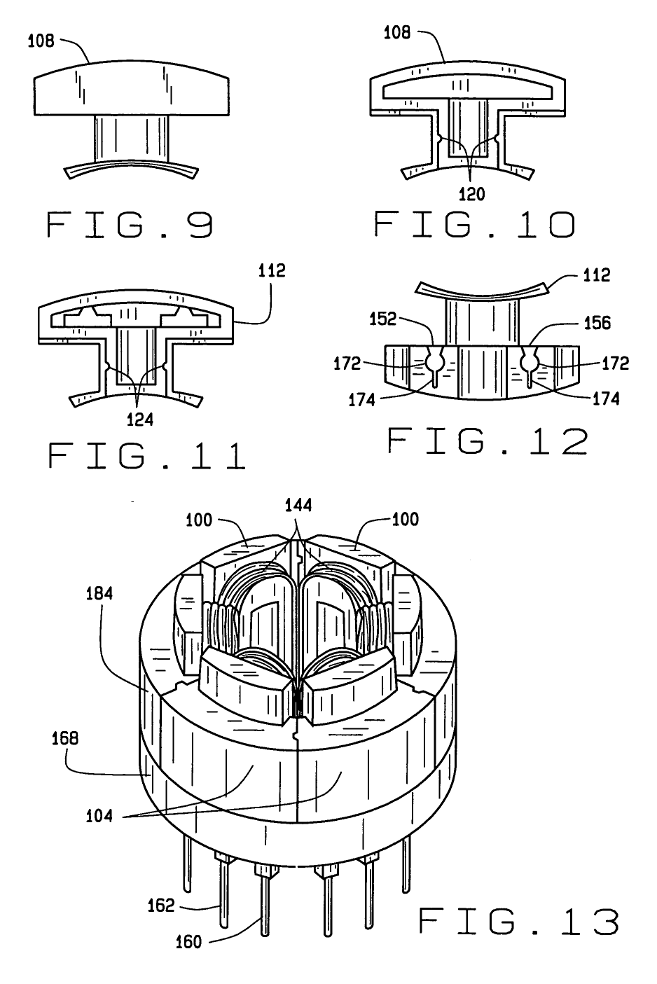

As shown in FIG. 6, the end cap 100 can be sized such a portion 180 thereof extends upwardly beyond an end 182 of the stator segment 104. This feature can be beneficial in those instances in which the stator segment 104, or fully assembled stator 184 (as shown in FIG. 13 and 14) is laid topside down on a horizontal support surface (e.g., table, work bench, etc.). In which case, the end cap portion 180 can help protect the stator winding 144 from possible damage that might otherwise be caused by physical contact between the stator winding 144 and the support surface.

A wide range of materials can be used for the end cap 100. In preferred implementations, the end cap 100 is formed from one or more electrically insulative materials such as plastic. In which case, the end cap 100 can electrically insulate the stator winding 144 from the stator segment 104, end shield 168, and housing 186.

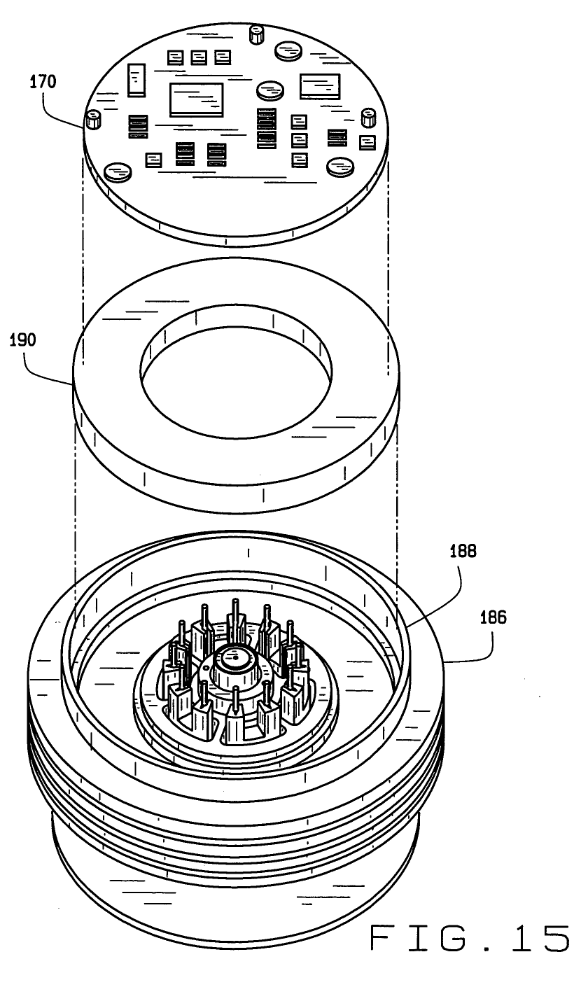

FIGS. 13 through 15 illustrate an exemplary implementation in which six end caps 100 are used in conjunction with the circumferentially segmented stator 184 including six stator segments or teeth 104, and the end shield 168 defining six circumferentially arranged windows 166. Alternative implementations, however, can include using one or more end caps with segmented stators having more or less than six stator segments and/or end shields defining more or less than six openings depending on the particular application. Indeed, some implementations include using one or more end caps with a non-segmented or full round stator. For example, FIG. 16 illustrates six end caps 200 coupled to a non-segmented stator 284, which, in turn, is positioned on an end shield 268.

With further reference to FIG. 15, the end caps 100, segmented stator 184, and end shield 168 are shown positioned within an exemplary housing 186. As shown, each end cap 100 guides a corresponding pair of lead and exit ends 160, 162 through a different window 166 in the end shield 168 and into housing portion 188. By properly positioning and retaining the position of the stator winding lead and exit ends 160, 162 within the housing portion 188, the end caps 100 can facilitate the integration of power and control electronics assembly 170 and mount 190 into the housing 186. Exemplary processes for integrating power and control electronics into a primary machine housing are described in U.S. patent application Ser. No. ______ (Attorney Docket No. 5260-000188), filed on even date herewith, entitled “Electric Machine with Power and Control Electronics Integrated into the Primary Machine Housing”, the entire disclosure of which is incorporated herein by reference.

In another form, the present invention provides methods for positioning and retaining the position of lead and exit ends of at least one winding of an electric machine. In one implementation, the method generally includes engaging the lead and exit ends within first and second grooves defined by an end cap coupled to a segmented or non-segmented stator. The end cap guides the lead and exit ends engaged within the first and second grooves through at least one opening in an end shield.

To removably engage the end cap to the stator, the method can also include slidably positioning first and second pieces of the end cap around an engagement member of the stator. In various implementations, the engagement of the end cap to the stator can also include slidably positioning ribs defined by the first and second pieces within grooves defined by the stator. The method can further include wrapping a wire around a generally curved surface defined by the first and second pieces to form the winding. Further implementations can include positioning a bent portion of each of the lead and exit ends within a relief defined by the end cap adjacent the corresponding one of the first and second grooves.

Accordingly, various implementations of the invention provide end caps capable of locating and controlling the stator winding lead and exit positions. This, in turn, enables the stator windings to be connected directly to power and control electronics without secondary connections and lead frames and the processes, costs, increased electrical resistance, and electrical current reductions associated with these secondary connections and lead frames. By properly positioning and retaining the position of the stator winding lead and exit end, various implementations of the invention can facilitate automated assembly and the integration of power and control electronics into the primary machine housing.

Various aspects of the present invention can be used in a wide range of electric machines, electric motors, electric superchargers, switched reluctance motors, brushless permanent magnet (BPM) motors, induction motors, and electric generators. Accordingly, the specific references to electric machine herein should not be construed as limiting the scope of the present invention to only one specific form/type of electric machine.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An electric machine comprising a stator, an end shield defining at least one opening therein, at least one winding including a lead end and an exit end, and at least one end cap coupled to the stator, the end cap defining first and second grooves, each of the first and second grooves engaging one of said lead and exit ends, the end cap guiding the lead and exit ends through the opening in the end shield.

2. The machine of claim 1, wherein the end cap defines a relief adjacent each said first and second groove, and wherein a bent portion of each said lead and exit ends is positioned within the corresponding relief.

3. The machine of claim 1, wherein the end cap defines a generally curved surface around which wire is wound thereby forming the winding.

4. The machine of claim 3, wherein the end cap includes a flange disposed at least partially around the generally curved surface to retain the wire on the generally curved surface.

5. The machine of claim 1, wherein the end cap defines at least one rib slidably received within at least one groove defined by the stator, thereby removably securing the end cap to the stator.

6. The machine of claim 1, wherein the end cap comprises first and second pieces slidably positioned generally around an engagement member of the stator.

7. The machine of claim 6, wherein the first and second pieces cooperate to define a generally curved surface around which wire is wound thereby forming the winding.

8. The machine of claim 1, wherein the end cap includes a pair of legs each defining a different one of said first and second grooves.

9. The machine of claim 1, wherein the first and second grooves are configured to form a snap-fit with the lead and exit ends.

10. The machine of claim 1, wherein each said groove includes a cross-section having a first generally unshaped portion, and a second generally unshaped portion extending from and narrower than the first generally unshaped portion.

11. The machine of claim 1, wherein the end cap electrically insulates the winding from the stator, the end shield, and the housing.

12. An electric supercharger comprising the machine of claim 1.

13. A vehicle comprising the electric supercharger of claim 12.

14. An electric machine comprising a segmented stator including a plurality of stator segments, an end shield defining a plurality of openings therein, a plurality of windings each including a lead end and an exit end, and a plurality of end caps each coupled to a different one of said stator segments, each said end cap defining first and second grooves, each of the first and second grooves engaging one of said lead and exit ends, each said end cap guiding a corresponding pair of lead and exit ends through a different one of said openings in the end shield.

15. A method for positioning and retaining the position of lead and exit ends of at least one winding of an electric machine, the method comprising engaging the lead and exit ends within first and second grooves defined by an end cap coupled to a stator, the end cap guiding the lead and exit ends engaged within the first and second grooves through at least one opening in an end shield.

16. The method of claim 15, further comprising slidably positioning first and second pieces of the end cap around an engagement member of the stator to removably couple the end cap to the stator.

17. The method of claim 16, wherein slidably positioning includes slidably positioning ribs defined by the first and second pieces within grooves defined by the stator.

18. The method of claim 16, further comprising wrapping a wire around a generally curved surface defined by said first and second pieces to form the winding.

19. The method of claim of claim 16, wherein engaging includes positioning a bent portion of each said lead and exit end within a relief defined by the end cap adjacent the corresponding one of the first and second grooves.

20. A end cap for a stator, the end cap defining first and second grooves, each of the first and second grooves being sized to engage one of a lead end and exit end of a winding, the end cap guiding and retaining the position of the lead and exit ends engaged within the respective first and second grooves.

21. The end cap of claim 20, wherein the end cap defines a relief adjacent each said first and second groove and sized to accommodate a bend in each of said lead and exit ends thereby allowing the lead and exit ends to lay generally flat within the corresponding first and second grooves.

22. The end cap of claim 20, wherein the end cap defines at least one rib sized to be slidably received within at least one groove defined by a stator to removably secure the end cap to the stator.

23. The end cap of claim 20, wherein the end cap includes first and second pieces configured to be slidably positioned generally around an engagement member of a stator.

24. The end cap of claim 23, wherein the first and second pieces cooperate to define a generally curved surface around which wire can be wound to form the winding.

25. The end cap of claim 20, wherein the end cap defines a generally curved surface around which wire is wound thereby forming the winding.

26. The end cap of claim 25, further comprising a flange disposed at least partially around the generally curved surface to retain the wire on the generally curved surface.

27. The end cap of claim 20, wherein the end cap includes a pair of legs each defining a different one of said first and second grooves.

28. The end cap of claim 20, wherein each of the first and second grooves is configured to form a snap-fit with the lead and exit ends.

29. The end cap of claim 20, wherein each of the first and second grooves includes a cross-section having a first generally u-shaped portion, and a second generally u-shaped portion extending from and narrower than the first generally u-shaped portion.
